(19) United States
(12) Patent Application Publication
(10) Pub. No.: US 2025/0029584 A1
(43) Pub. Date: Jan. 23, 2025

(54) Automatic Music-Queuing, Karaoke Management and Track Mixing

(71) Applicant: Siddharth Ray, Folsom, CA (US)

(72) Inventor: Siddharth Ray, Folsom, CA (US)

(73) Assignee: Saddharth Ray, Folsom, CA (US)

(21) Appl. No.: 18/223,512

(22) Filed: Jul. 18, 2023

(51) Int. Cl. G10H 1/36; G06F 16/638

(52) U.S. Cl. CPC G10H 1/361; G06F 16/639

(57) ABSTRACT

A mechanism is described for facilitating automatic music-queuing, karaoke managing, and track mixing. A method, as described herein, includes receiving, at a computing device, a guest elevation request from a guest client device in communication with the computing device including a server computing device serving as a host computer, where the guest elevation request includes prioritizing a request for an audio track or a video clip placed by a user via the guest client device. The method may further include performing analysis of the guest elevation request to determine whether to approve or disapprove the guest elevation request, and elevating the guest client device associated with the guest elevation request if the guest elevation request is approved. The method may further include communicating the approval of the guest elevation request and the elevation of the guest client device to the guest client device over a communication network.

### FIELD

Embodiments generally relate to media and more particularly, to group music-streaming, specifically for large groups of people (but not limited to), usually in a party or gathering, but can be used anywhere.

### BACKGROUND

People gathering in an event, either formal or informal, and dancing to or enjoying music that is being streamed live, is a very common occurrence. The size of these gatherings ranges from very small (handful of friends or families), to very large, professionally hosted events with thousands of people (such as a large New Year's Eve event). Regardless of the size of the event, the guests like to listen to their favorite songs, or dance to those. Guests prefer to have an interactive format, where they can request specific songs to play, share their requests with other guests, respond to the numbers played recently, and give preference on what genre of song they would like to hear at a given time.

Currently, managing an interactive playlist during an event, gathering or a party, with guest's live requests, requires manual intervention. There is usually a disk jockey (DJ) or a host, who takes requests from guests, updates the playlist, and mixes the music accordingly. The DJ also chooses songs based on the mood of the guests, such as selecting songs that caters to guests' likes, which can be changing as the event progresses.

Having humans manage these tasks is labor intensive (leading to higher cost), and subject to human errors as well. Manually taking requests when there are hundreds of guests is also not practical at all. Similarly, guests manually sharing their preferences with other guests and responding to current songs being streamed is practically impossible to do in a structured way with hundreds of guests.

Some events include a “Guest Karaoke” section, where some guests can sing to background tracks streamed or played by the DJ. The DJ is usually responsible for managing the guest singers and playing their respective tracks. This is a manual labor-intensive task, leading to high cost and wasted time.

### BRIEF DESCRIPTION OF THE DRAWINGS

For a more complete understanding of embodiments, reference is made to the following description and accompanying drawings, in which:

FIG. 1 is block diagram showing the architecture for “Guest Picks” (see [0023] for definition of Guest Picks) function;

FIG. 2 is block diagram showing the architecture of “Guest DJ Mix” using Remote DJ Protocol (see [0026], [0027] and [0028] for details);

FIG. 3 is block diagram showing the flowchart of Remote DJ protocol in the perspective of the DJ Host (see [0029] for details);

FIG. 4 is block diagram showing the flowchart of the Remote DJ Protocol in the perspective of the Guest Client (see [0030] for details);

FIG. 5 is block diagram showing the flowchart of the Guest Picks architecture in the perspective of the DJ Host (see [0031] for details);

FIG. 6 is block diagram showing flowchart of the Guest Pick architecture in the perspective of the Guest Client (see [0032] for details);

FIG. 7 is a computing system capable of implementing one or more embodiments described in this document.

FIG. 8 is block diagram showing flowchart of the Guest Karaoke Management architecture in the perspective of the DJ Host (see [0033] for details);

FIG. 9 is block diagram showing flowchart of the Guest Karaoke Management architecture in the perspective of the Guest Client (see [0034] for details);

### DETAILED DESCRIPTION OF THE PREFERRED EMBODIMENT

Embodiments to automate many of the human DJ tasks in an event, overcoming the limitations of the conventional techniques. In one embodiment, data-driven computer algorithms are used to make superior decisions on playlist management compared to a human DJ. Embodiments provide for a high level of user experience for the guest's interaction with the playlists, such as providing guest preferences, sharing preferences with other guests, and responding (such as “like” or “dislike”) to the recent tracks being played.

Another embodiment provides for a technique to mix music that the guests would typically interact with, in a simulated and artistic manner, to emulate a live DJ.

Embodiments significantly enhance karaoke management in events. In one embodiment, human tasks associated with karaoke are automated, such as guest's request to participate in the karaoke, guest's selection of the songs they would like to sing, guest's selection of the background tracks, notification to guests when their turn is up, etc.

Still other embodiments are described as will be obvious and apparent from the specification and drawings throughout this document.

Embodiments comprise several stages and the relation of one or more of such stages with respect to each of the others, and the apparatus embodying features of construction, combinations of elements and arrangement of parts that are adapted to affect such stages, all is exemplified in the following detailed disclosure, and the scope of the embodiments will be indicated in the claims.

The combined functions of “Guest Picks”, “Guest DJ Mix”, “Assisted Karaoke”, “AI DJ Mix”, “Song Transfer Protocol” and others listed below make up these embodiments.

In one embodiment, a mechanism (including software, or hardware, or a combination thereof), referenced herein after as “the DJ Host”, may include software running on any operating system (OS) or device type or online to control and play songs, which, in one embodiment, is controlled by a computing device serving as the event host (referenced hereinafter as “the Host” or “the Admin”), a software (referenced hereinafter as “the Guest Client”), that may run online or on a native OS application for any device type (including, but not limited to, smartphones, tablets, laptops, desktops, etc.), that can request songs, interact with other party functions, and view party information provided by the DJ Host. Embodiments further provide a database and associated software (“the Database”), hosted on the Cloud, to facilitate communication between the Guest Client and DJ Host, and save event's data. In one embodiment, it also includes an additional software (Such as Display Software Client (DSC)) that shows party statistics and/or information to the guests from a shared display, such as a television, a monitor, etc.

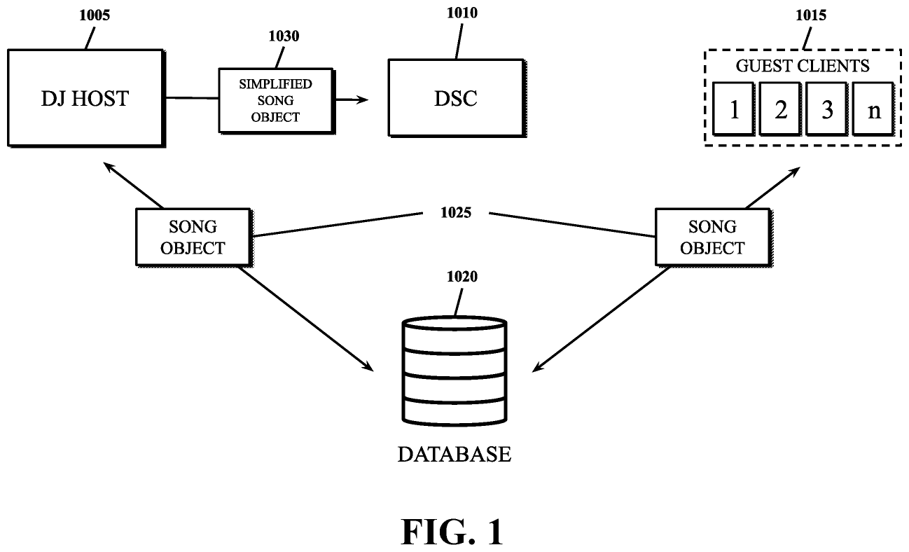

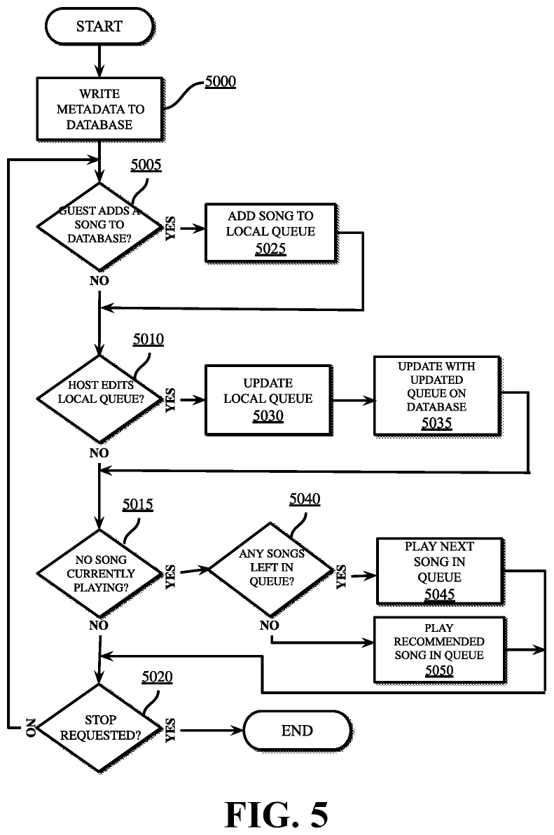

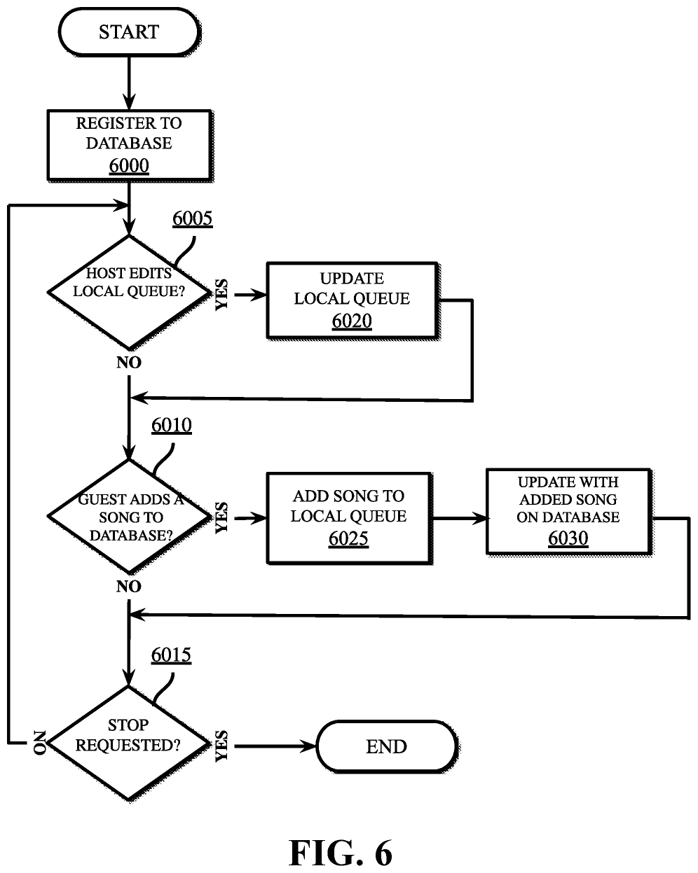

“Guest Picks” allows the event guests to request songs through the flow shown in FIG. 1. For example, it uses the following elements: DJ Host 1005, the Database 1020, Guest Clients 1015, Song Object 1025, Simplified Song Object 1030, DSC 1010. The event's guests can request a song or video to be played in the event, by using Guest Client 1015 running on their mobile/personal device. Guest Clients (1015) show the current play-list (such as a list of songs to be played in the event). Any guest requesting a new song is to be added to the play-list, where the Guest Clients 1015 shows the up-to-date list. A requested song or video is sent to Database 1020 as Song Object 1025, where Database 1020 then sends Song Object 1025 to DJ Host 1005 to be queued and played automatically by the DJ Host, where Database 1020 then sends the updated queue to Guest Clients 1015. A Song Object 1025 contains song information such as but not limited to song title, song artist, song link/audio data, and the requesting Guest Client's 1015 information. DJ Host 1005 then sends Simplified Song Object 1030 to Display Software Client 1010, which shows the name of the guest who requested the song, song thumbnail image, and the upcoming songs in the queue. Simplified Song Object 1030 contains only necessary information about a song the Display Software Client 1010 requires, such as but not limited to song title, song artist, song thumbnail image, and name of the requesting Guest Client. FIG. 5 shows the Guest Picks flowchart regarding DJ Host 1005. FIG. 6 shows the Guest Picks flowchart relating to Guest Clients 1015.

Referring back to FIG. 1, Song Transfer Protocol (STP) starts at Guest Clients 1015, where one of the Guest Clients 1016 sends a Song Object 1025, holding song data such as the title of the song, queue position of the song, and any other relevant song information, to Database 1020, where it is stored. Database 1020 send a notification to DJ Host 1005 and all Guest Clients 1015 along with Song Object 1025, where DJ Host 1005 and all Guest Clients 1015 update to reflect the changes in Database 1020. In one embodiment, this process is advanced by DJ Host 1005, such as DJ Host 1005 sending Song Object 1025 to Database 1020, but Database 1020 may not send a notification to DJ Host 1005 and only send a notification to all Guest Clients 1015. This protocol may be called multiple times in sequence in order to transfer an entire queue of songs.

“AI DJ Mix” is a function of DJ Host 1005, where DJ Host 1005 selects appropriate songs and background tracks to mix and play, where DJ Host 1005 may use artificial intelligence (AI) techniques and algorithms to select which songs and tracks, when mixed, that will result in forming melodious music.

“Guest DJ Mix” is a function where the guests can add live special effects and have more advanced controls to affect the music being played, via Guest Clients 1015. Such special effects are, but not limited to, adding a “disk scratch” sound effect, modulating the frequency bands, slowing down or speeding up the audio, selecting tracks, etc. Using DJ Host 1005, the Admin can pick any guest, using any of multiple methods such as but not limited to random selection or user-inputted selection, to enable the “Guest DJ Mix” function on their respective devices, such as Guest Devices 1015, and that guest can then add special effects to the music being played for a limited amount of time. Guest Clients 1015 may use Remote Disc Jockey Protocol (RDJP) to communicate with DJ Host 1005. This feature intends to increase guest involvement.

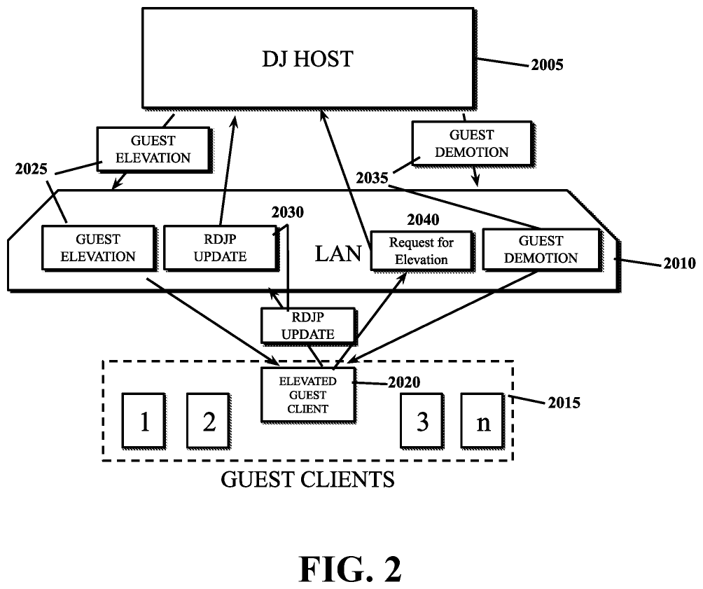

FIG. 2 shows an embodiment of the Guest DJ Mix function. In one embodiment, the Admin manipulates a play-list, using DJ Host 2005. When DJ Host 2005 facilitates the start of a Guest DJ Mix, one or more Guest Clients 2015 send requests for elevation 2040 and, in turn, DJ Host 2005 returns Guest Elevations 2025 to one specific Guest Client, henceforth referred to as Elevated Guest Client 2020, which may be chosen randomly or selected with the employment of any of multiple methods. The selected Elevated Guest Client 2020 is now able to send RDJP Updates 2030 to DJ Host 2005. Any attempts from Guest Clients 2015 that are not elevated to send RDJP Updates 2030 to the DJ Host 2005 may be rejected by the DJ Host 2005 and may not be fulfilled.

For example, RDJP Updates 2030 may contain track and/or song control information that Elevated Guest Client 2020 has requested. The mechanism hosted by DJ Host 2005 may use the control information to mix the currently running track accordingly, wherein the Guest DJ Mix may be terminated when DJ Host 2005 sends RDJP Demotion 2035 to the Elevated Guest Client 2020, which is now considered as one of the ordinary Guest Clients 2015. Any RDJP Updates 2030 sent after RDJP Demotion 2035 or before RDJP Elevation may be rejected as described in [0027]. Any communications made between DJ Host 2005 and any Guest Clients, including Elevated Guest Client 2020, are channeled through a communication network 2010, such as Local Area Network (LAN), or other means or techniques, such as an external server/database acting as a proxy (not shown but acts similar to LAN in relation to other elements).

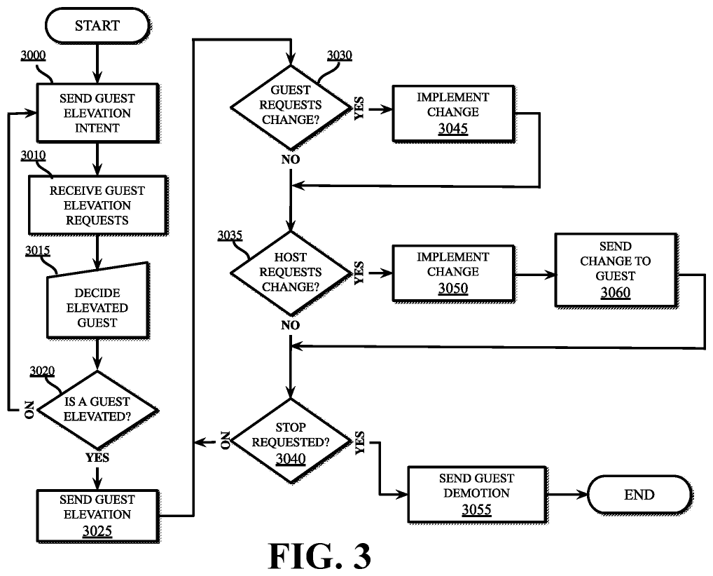

FIG. 3 shows the flowchart for RDJP in the perspective of the DJ Host. In Block 3000 the DJ Host sends all connected Guest Clients an intent to elevate. In Block 3010, the DJ host receives elevation requests from Guest Clients who chose to participate. In block 3015, DJ host decide which Guest Client will be elevated. If no Guest Client participates, or if no Guest Client is elevated (block 3020 “No” arc), the DJ host loops back to block 3000 and re-sends intent to elevate to the Guest Clients. Once a Guest Client is selected for Elevation, through any of multiple means, such as, but not limited to, random selection or manual selection by the host, the DJ Host sends a Guest Elevation to the specified Guest Client (block 3025), now referred to as the Elevated Guest Client(s). In the block 3030, the DJ Host is checking for updates from the Elevated Guest Client, such as but not limited to transitions to a new song, or adding special effects, such as, but not limited to, echo, scratch sound, or modulate bands. DJ Host applies the requested updates by modifying the audio output being played live (3045). During this time, the DJ Host also can make changes and send that update to the Guest Clients (3035, 3050, 3060). Once the DJ Host decides to stop the process (block 3040), the DJ Host sends the Elevated Guest Client a Guest Demotion Request (block 3055) and may no longer accept any requested changes from that Guest Client. FIG. 3 flowchart process now ends. DJ Host may restart the process again to select a different Guest Client to elevate.

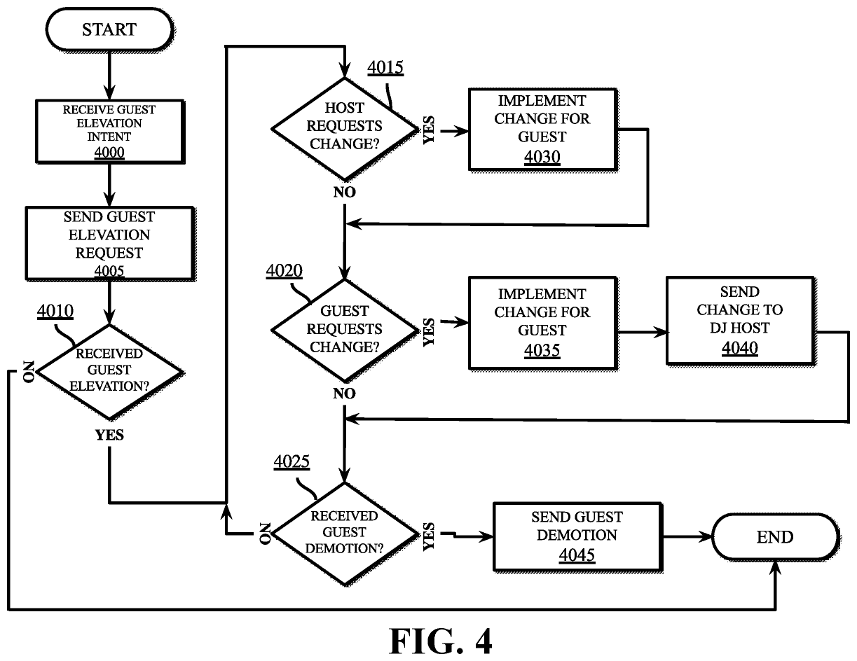

FIG. 4 shows the flowchart for RDJP in the perspective of the Guest Client. In Block 4000 Guest Clients receive Elevation Intent from DJ Host. The Guest Clients who are interested to participate in RDJP sends Elevation Request (Block 4005) to DJ Host (in this example, Guest Client portrayed in the flowchart is interested to participate). If the Guest Client receives a Request Denial from DJ Host (Block 4010 “No” arc), then the process ends. If the Guest Client receives Request Approval from DJ Host (Block 4010 “Yes” arc), then the Guest Client can request change (4020) such as transition to a new song, or adding special effects such as echo, scratch sound, modulate bands etc. The change is reflected in Guest Client (4035) and then send to DJ Host (4040). Meanwhile, if the DJ Host implements any changes (4015), then it is reflected on the Guest Client (4030). If the Guest Client receives a Guest Demotion request from DJ Host (4025), then it send an acknowledgement (4045) to DJ Host and proceeds to end the flow.

FIG. 5 is showing the DJ Host side flowchart of the Guest Pick architecture. In Block 5000, DJ Host sets the default settings of the session in the Database. The settings include, but not limited to, User ID of the DJ Host, a pass-key/code used by Guests to join the session and other administrative settings. In 5005, the DJ Host checks if a new song or track has been requested by the Guest Client to be added to the queue. If that is true, DJ Host adds the new song to the DJ Host's local copy of the queue (5025). In Block 5010, DJ Host checks if the Admin made any local modification to the local copy of the Queue (including, but not limited to, add or delete a song in the queue). If that is true, both the local queue and the Database is updated to reflect the changes (5030 and 5035). Blocks 5015, 5040 and 5045 picks the next song from the queue to be played when the current song finishes (Block 5045). If there are no songs left in the Queue (Block 5040 “No” arc), the DJ Host plays a “recommended” song from the previously played songs—which includes, but not limited to, a random song from the previously played song in this session, or a song that Admin manually selects (Block 5050). The loop continues until a stop is requested by the Admin (Block 5020).

FIG. 6 is a block diagram showing the flowchart of the Guest Pick architecture in the perspective of the Guest Client. In Block 6000, the Guest Client first registers to the Database by providing the session pass-key, user name, and other miscellaneous metadata. In Block 6005, Guest Client checks if the DJ Host has made an update to the Queue in Database. If that is true, the Guest Client's local copy of the Queue is updated to reflect the change (6020). Blocks 6010, 6025 and 6030 handles the event when the Guest requests a song to be added to Queue (6010). The song is added to both the Guest local queue (6025) and the Database (6030). The loop continues until the DJ Host request a Stop event to the Guest (6015).

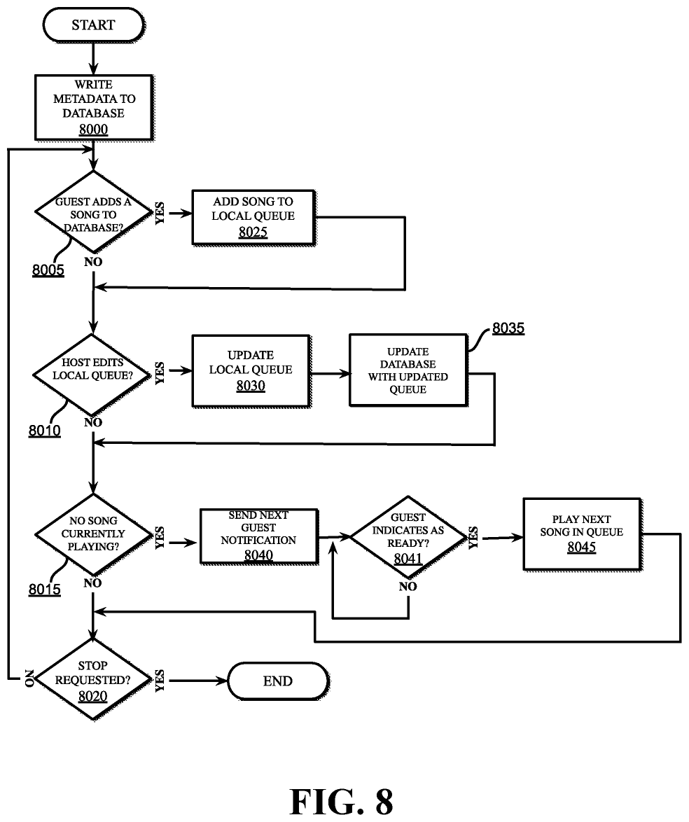

FIG. 8 is a block diagram showing the flowchart of the Karaoke Management architecture in the perspective of the DJ Host. In block 8000, DJ Host sets the default settings and/or metadata of the session in The Database. The settings include, but not limited to, User ID of the DJ Host, a passkey/code used by guests to join the session and other administrative settings. In 8005, DJ Host checks if any Guest Client has added a new Karaoke track to the database. In that case, the Song Object of the track is read from the Database and is added to the local copy of the DJ Host's queue (8025). The DJ Host may perform edits of the queue for moderation or technical purposes, such as, but not limited to, removing tracks deemed inappropriate or tracks not compatible for various technical reasons (8010). In blocks 8010, 8030, and 8035, updates to the karaoke queue made by the DJ Host are reflected in the local queue of the DJ Host as well as propagated to the Database. In 8015, the DJ Host checks if any karaoke track is currently playing. If not, it sends a notification to the Guest Client who submitted the next track in the queue (block 8040). Then the DJ Host waits until that Guest Client notifies that they are ready to perform to the karaoke track (8041). Once the notification arrives, the DJ Host plays the next track from the queue (8045). The process continues until a stop is requested by the Admin (8020).

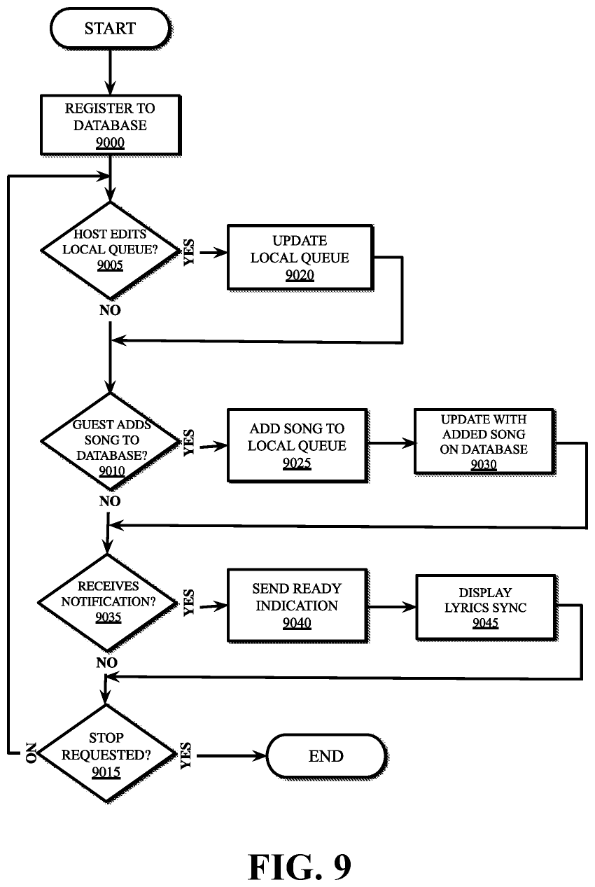

FIG. 9 shows the block diagram of the Karaoke Management Architecture flowchart on the Guest device. In Block 9000, the Guest Client first registers to the Database by providing the session pass-key, user name, and other miscellaneous metadata. In Block 9005, Guest Client checks if any changes to the karaoke queue have been made by the DJ Host or other Guest Clients. If true, these changes are reflected in this Guest Client's local queue (9020). When this guest adds a karaoke track to the queue (9010, “Yes” arc) the track is added to the local queue of this Guest Client (9025) as well as the queue in Database (9030), which is propagated later to other Guest Clients (9005, 9020). In block 9035, Guest checks if it received any notification from the DJ Host to perform to any of karaoke track that they have added to queue. This will result to a prompt on the Guest Client for the human guest to indicate when they are ready to perform to the track. When the Guest Client sends the “Ready Indication” (9040), the Guest Client will start displaying the track lyrics on the guest device. The lyrics are synchronized with the karaoke audio played by the DJ Host, using any of the available synchronization techniques. When the DJ Host closes the karaoke session, a Stop request is sent to Guest Client (9015, “Yes” arc), and the process ends.

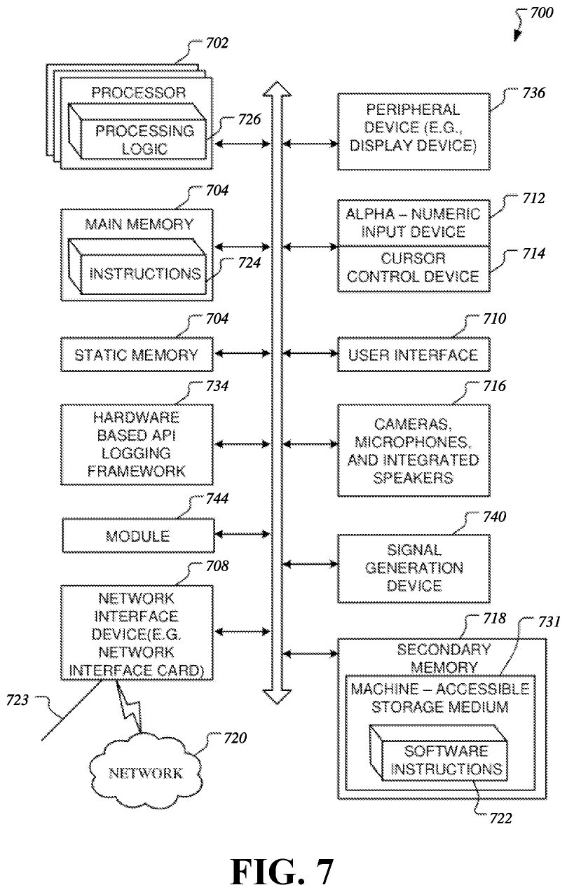

FIG. 7 illustrates a diagrammatic representation of a machine 700 in the exemplary form of a computer system, in accordance with one embodiment, within which a set of instructions, for causing machine 700 to perform any one or more of the methodologies discussed herein, may be executed. Machine 700 may be the same as or similar to or contained within or include apparatus 1005, 1015 and 1020 of FIG. 1 to perform or execute one or more methodologies discussed throughout this document. In alternative embodiments, machine 700 may be connected (e.g., networked) to other machines either directly, such as via media slot or over a network, such as a cloud-based network, a Local Area Network (LAN), a Wide Area Network (WAN), a Metropolitan Area Network (MAN), a Personal Area Network (PAN), an intranet, an extranet, or the Internet. The machine may operate in the capacity of a server or a client machine in a client-server network environment, or as a peer machine in a peer-to-peer (or distributed) network environment or as a server or series of servers within an on-demand service environment, including an on-demand environment providing multi-tenant database storage services. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 700 includes one or more processors 702, a main memory 704 (e.g., read-only memory (ROM), flash memory, dynamic random access memory (DRAM) such as synchronous DRAM (SDRAM) or Rambus DRAM (RDRAM), etc., static memory 742, such as flash memory, static random access memory (SRAM), volatile but high-data rate RAM, etc.), and a secondary memory 718 (e.g., a persistent storage device including hard disk drives and persistent multi-tenant data base implementations), which communicate with each other via a bus 730. Main memory 704 includes instructions 724 (such as software 722 on which is stored one or more sets of instructions 724 embodying any one or more of the methodologies or functions of material mechanism 710 of computing device 700 of FIG. 7 and other figures described herein) which operate in conjunction with processing logic 726 and processor 702 to perform the methodologies discussed herein.

Processor 702 represents one or more general-purpose processing devices such as a microprocessor, central processing unit, or the like. More particularly, the processor 702 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 702 may also be one or more special-purpose processing devices such as an application specific integrated circuit (ASIC), a field programmable gate array (FPGA), a digital signal processor (DSP), network processor, or the like. Processor 702 is configured to execute the processing logic 726 for performing the operations and functionality of material mechanism 710 of computing device 700 of FIG. 7 and other figures discussed herein.

The computer system 700 may further include a network interface device 708, such as a network interface card (NIC). The computer system 700 also may include a user interface 710 (such as a video display unit, a liquid crystal display (LCD), or a cathode ray tube (CRT)), an alphanumeric input device 712 (e.g., a keyboard), a cursor control device 714 (e.g., a mouse), a signal generation device 740 (e.g., an integrated speaker), and other devices 716 like cameras, microphones, integrated speakers, etc. The computer system 700 may further include peripheral device 736 (e.g., wireless or wired communication devices, memory devices, storage devices, audio processing devices, video processing devices, display devices, etc.). The computer system 700 may further include a hardware-based application programming interface logging framework 734 capable of executing incoming requests for services and emitting execution data responsive to the fulfillment of such incoming requests.

Network interface device 708 may also include, for example, a wired network interface to communicate with remote devices via network cable 723, which may be, for example, an Ethernet cable, a coaxial cable, a fiber optic cable, a serial cable, a parallel cable, etc. Network interface device 708 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported. In addition to, or instead of, communication via the wireless LAN standards, network interface device 708 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

The secondary memory 718 may include a machine-readable storage medium (or more specifically a machine-accessible storage medium) 731 on which is stored one or more sets of instructions (e.g., software 722) embodying any one or more of the methodologies or functions of material mechanism 710 of FIG. 7 and other figures described herein. The software 722 may also reside, completely or at least partially, within the main memory 704, such as instructions 724, and/or within the processor 702 during execution thereof by the computer system 700, the main memory 704 and the processor 702 also constituting machine-readable storage media. The software 722 may further be transmitted or received over network 720 via the network interface card 708. The machine-readable storage medium 731 may include transitory or non-transitory machine-readable storage media.

Portions of various embodiments may be provided as a computer program product, which may include a computer-readable medium having stored thereon computer program instructions, which may be used to program a computer (or other electronic devices) to perform a process according to the embodiments. The machine readable medium may be transitory or non-transitory and include, but is not limited to, floppy diskettes, optical disks, compact disk read-only memory (CD-ROM), and magneto-optical disks, ROM, RAM, erasable programmable read-only memory (EPROM), electrically EPROM (EEPROM), magnet or optical cards, flash memory, or other type of media/machine-readable medium suitable for storing electronic instructions.

Modules 744 relating to and/or include components and other features described herein (for example in relation to material mechanism 710 of computing device 700 as described with reference to FIG. 7) can be implemented as discrete hardware components or integrated in the functionality of hardware components such as ASICS, FPGAs, DSPs or similar devices. In addition, modules 744 can be implemented as firmware or functional circuitry within hardware devices. Further, modules 744 can be implemented in any combination hardware devices and software components.

The techniques shown in the figures can be implemented using code and data stored and executed on one or more electronic devices (e.g., an end station, a network element). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals-such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. Of course, one or more parts of an embodiment may be implemented using different combinations of software, firmware, and/or hardware.

In some embodiments, database, described throughout this document, may include one or more of storage mediums or devices, repositories, data sources, etc.

In some embodiments, input/output (I/O) may further include any number or type of input/output devices, such as alpha-numeric devices 712 or cursor control devices 714 or peripheral devices 736 including, but not limited to, microphone(s), camera(s), speaker(s), display(s), touch screens, head-mounted displays (HMDs), etc., for capture or presentation of data, and any number and type of speaker or display devices for presentation and communication of output, feedback, etc.

Throughout this document, a “user” may refer to someone, like a person or one or more persons, or a group of persons, having access to one or more computing devices, such as DJ Host 1005 or Guest Clients 1015 of FIG. 1.

Further, throughout this document, terms like “logic”, “component”, “module”, “framework”, “engine”, “tool”, “circuitry”, and/or the like, may be referenced interchangeably and include, by way of example, software, hardware, firmware, and/or any combination thereof.

It is contemplated that any number and type of components may be added to and/or removed from the system or architecture as described in FIG. 1, wherein such components may include or be based on software, hardware, firmware, or any combination thereof. For brevity, clarity, and ease of understanding, many of the standard and/or known components, such as those of a computing device are not shown or discussed here. It is contemplated that embodiments, as described herein, are not limited to any technology, topology, system, architecture, and/or standard and are dynamic enough to adopt and adapt to any future changes.

Any of the above embodiments may be used alone or together with one another in any combination. Embodiments encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements. It is to be understood that the above description is intended to be illustrative, and not restrictive.

What is claimed is:

1. A computer-readable medium having stored thereon instructions which, when executed, cause a computing device to perform operations comprising:
receiving a guest elevation request from a guest client device in communication with the computing device including a server computing device serving as a host computer, wherein the guest elevation request includes prioritizing a request for an audio track or a video clip placed by a user via the guest client device;
performing analysis of the guest elevation request to determine whether to approve or disapprove the guest elevation request;
elevating the guest client device associated with the guest elevation request if the guest elevation request is approved; and
communicating the approval of the guest elevation request and the elevation of the guest client device to the guest client device over a communication network.

2. The computer-readable medium of claim 1, wherein the operations comprise playing the audio track or the video clip using an audio-video system coupled to the computing device, wherein the audio track or the video clip includes an audio or video, respectively, of a song, a speech, a book, or a film, and wherein the guest client device includes a mobile device having a smartphone or a tablet device.

3. The computer-readable medium of claim 2, wherein playing of the audio track or the video clip having a karaoke track of a song includes playing of the karaoke track in synchronization with displaying lyrics of the karaoke song using the audio-video system.

4. The computer-readable medium of claim 1, wherein the operations further comprise:
detecting guest interaction between guests through their corresponding guest client devices based on one or more detection techniques including gesture detection machine learning techniques, and further ensuring privacy of the guest client devices using one or more privacy techniques including live-video hashing system; and
receiving feedback from the guest client device and ranking audio tracks or video clips based on the feedback, wherein the ranking is performed based on one or more artificial intelligence-based ranking techniques to keep the guest client devices engaged by continuing to shuffle and play high-ranking audio tracks or video clips.

5. The computer-readable medium of claim 1, wherein the operations further comprise:
inferring user engagement metric based on audio inputs or video inputs from the guest client devices, wherein the inputs are obtained through one or more of microphones or cameras associated with the guest client devices; and
facilitating guest client devices to add live special events or have advanced controls to audio tracks or video clips being played.

6. The computer-readable medium of claim 1, wherein the operations further comprise:
demoting the guest client device associated with the guest elevation request if the guest elevation request is disapproved;
communicating the disapproval of the guest elevation request and the demotion of the guest client device to the guest client device over the communication network; and
notifying the guest client device of changes to be made to the guest elevation request if the guest elevation request is fails to meet a minimum request protocol, wherein the guest elevation request that fails to meet the minimum request protocol is neither approved nor disapproved.

7. A method comprising:
receiving, at a computing device, a guest elevation request from a guest client device in communication with the computing device including a server computing device serving as a host computer, wherein the guest elevation request includes prioritizing a request for an audio track or a video clip placed by a user via the guest client device;
performing analysis of the guest elevation request to determine whether to approve or disapprove the guest elevation request;
elevating the guest client device associated with the guest elevation request if the guest elevation request is approved; and
communicating the approval of the guest elevation request and the elevation of the guest client device to the guest client device over a communication network.

8. The method of claim 7, further comprising playing the audio track or the video clip using an audio-video system coupled to the computing device, wherein the audio track or the video clip includes an audio or video, respectively, of a song, a speech, a book, or a film, and wherein the guest client device includes a mobile device having a smartphone or a tablet device.

9. The method of claim 8, wherein playing of the audio track or the video clip having a karaoke track of a song includes playing of the karaoke track in synchronization with displaying lyrics of the karaoke song using the audio-video system.

10. The method of claim 7, further comprising:
detecting guest interaction between guests through their corresponding guest client devices based on one or more detection techniques including gesture detection machine learning techniques, and further ensuring privacy of the guest client devices using one or more privacy techniques including live-video hashing system; and
receiving feedback from the guest client device and ranking audio tracks or video clips based on the feedback, wherein the ranking is performed based on one or more artificial intelligence-based ranking techniques to keep the guest client devices engaged by continuing to shuffle and play high-ranking audio tracks or video clips.

11. The method of claim 7, further comprising:
inferring user engagement metric based on audio inputs or video inputs from the guest client devices, wherein the inputs are obtained through one or more of microphones or cameras associated with the guest client devices; and
facilitating guest client devices to add live special events or have advanced controls to audio tracks or video clips being played.

12. The method of claim 7, further comprising:
demoting the guest client device associated with the guest elevation request if the guest elevation request is disapproved;
communicating the disapproval of the guest elevation request and the demotion of the guest client device to the guest client device over the communication network; and
notifying the guest client device of changes to be made to the guest elevation request if the guest elevation request is fails to meet a minimum request protocol, wherein the guest elevation request that fails to meet the minimum request protocol is neither approved nor disapproved.

13. A computing device having a processor and a memory coupled to the processor, wherein the processor to:
receive a guest elevation request from a guest client device in communication with the computing device including a server computing device serving as a host computer, wherein the guest elevation request includes prioritizing a request for an audio track or a video clip placed by a user via the guest client device;
perform analysis of the guest elevation request to determine whether to approve or disapprove the guest elevation request;
elevate the guest client device associated with the guest elevation request if the guest elevation request is approved; and
communicate the approval of the guest elevation request and the elevation of the guest client device to the guest client device over a communication network.

14. The computing device of claim 13, wherein the processor is further to play the audio track or the video clip using an audio-video system coupled to the computing device, wherein the audio track or the video clip includes an audio or video, respectively, of a song, a speech, a book, or a film, and wherein the guest client device includes a mobile device having a smartphone or a tablet device.

15. The computing device of claim 14, wherein playing of the audio track or the video clip having a karaoke track of a song includes playing of the karaoke track in synchronization with displaying lyrics of the karaoke song using the audio-video system.

16. The computing device of claim 13, wherein the processor is further to:
detect guest interaction between guests through their corresponding guest client devices based on one or more detection techniques including gesture detection machine learning techniques, and further ensuring privacy of the guest client devices using one or more privacy techniques including live-video hashing system; and
receive feedback from the guest client device and ranking audio tracks or video clips based on the feedback, wherein the ranking is performed based on one or more artificial intelligence-based ranking techniques to keep the guest client devices engaged by continuing to shuffle and play high-ranking audio tracks or video clips.

17. The computing device of claim 13, wherein the processor is further to:
infer user engagement metric based on audio inputs or video inputs from the guest client devices, wherein the inputs are obtained through one or more of microphones or cameras associated with the guest client devices; and
facilitate guest client devices to add live special events or have advanced controls to audio tracks or video clips being played.

18. The computing device of claim 13, wherein the processor is further to:
demote the guest client device associated with the guest elevation request if the guest elevation request is disapproved;
communicate the disapproval of the guest elevation request and the demotion of the guest client device to the guest client device over the communication network; and
notify the guest client device of changes to be made to the guest elevation request if the guest elevation request is fails to meet a minimum request protocol, wherein the guest elevation request that fails to meet the minimum request protocol is neither approved nor disapproved.
